(19) United States
(12) Patent Application Publication
(10) Pub. No.: US 2007/0293633 A1
(43) Pub. Date: Dec. 20, 2007

(54) Liquid crystalline polymer cpmposition and use thereof

(75) Inventors: Tomoya Hosoda, Tsukuba-shi (JP); Satoshi Okamoto, Tsukuba-shi (JP); Toshiki Mori, Tsukuba-shi (JP)

Correspondence Address: FOLEY AND LARDNER LLP;SUITE 500, 3000 K STREET NW, WASHINGTON, DC, 20007, US

(73) Assignee: Sumitomo Chemical Company, Limited

(21) Appl. No.: 11/808,839

(22) Filed: Jun. 13, 2007

(30) Foreign Application Priority Data
Jun. 15, 2006 (JP) 2006-165751

(51) Int. Cl. C08G 65/48

(52) U.S. Cl. 525/390

(57) ABSTRACT

The present invention provides a liquid crystalline polymer composition comprising (A) a polymer including units of formula (I), and units of formula (II) and/or units of formula (III), the units of formula (I) being included in 15-80% by mol, based on the total units [(I)+(II)+(III)]; and (B) a polymer (B) including units of formula (IV), formula (V) and the formula (VI), each of units being included in 30-80% by mol, 10-35% by mol and 10-35% by mol, respectively, based on the total units [(IV)+(V)+(VI)], the component (B) being included in 5-80% by weight based on the total weight of the components (A) and (B); wherein (I) —(VI) are —OC—Ar₁-0-, —O—Ar₂—O—, —OC—Ar₃—CO—, —OC—Ar₄—O—, —O—Ar₅—X— and —OC—Ar₆—CO—, respectively.

### BACKGROUND OF THE INVENTION

1. Field of the Invention

The present invention relates to a liquid crystalline polymer composition giving molded articles having high thin-wall flowability and small change in dimension caused during solder reflow, which are suitable for use in electronic parts; and to a molded article obtained from the liquid crystalline polymer composition.

2. Description of the Related Art

Liquid crystalline polymers having good moldability as well as high heat resistance and strength have been applied to electronic parts for surface mounting including, e.g., connectors, relays and switches.

Recently, the electronic parts, however, have been getting progressively lighter, thinner, shorter and smaller, and the liquid crystalline polymers to be used for the parts are required to have high thin-wall moldability accordingly. In addition, warpage of molded parts has also become an issue.

As a liquid crystalline polymer capable of inhibiting the occurrence of such warpage, for example, Japanese Patent Application Laid-Open Publication No. 2000-178443 (Examples) discloses a liquid crystalline polymer composition wherein fibrous filler and particulate filler are added to a liquid crystalline polymer.

These days, however, it is required that electronic parts and the like be processed more precisely. In order to satisfy such a requirement, liquid crystalline polymer compositions having a property capable of further lowering warpage compared to the conventional (hereinafter can be referred to as “lower-warpage property”) are required.

As a solder reflow process (heat treatment) is necessary for mounting electronic parts for surface-mounting, the parts are required to have good solder resistance (heat resistance). In particular, the materials thereof are required to have practical durability that swelling (blister deformation) caused during a solder reflow process is inhibited (hereinafter referred to as “blister resistance”). As to electronic parts for surface-mounting, produced from a liquid crystalline polymer, there have been occasional attempts to improve blister resistance. For example, Japanese Patent Application Laid-Open Publication No. 8-143654 (Claims) discloses that a resin composition including a liquid crystalline polymer with structure units derived from p-hydroxybenzoic acid in a reduced amount as a resin component can give electronic parts for surface-mounting having good blister resistance.

The liquid crystalline polymer compositions disclosed in Japanese Patent Application Laid-Open Publication No. 2000-178443 (Examples), however, may have insufficient property capable of lowering warpage (hereinafter possibly referred to as “lower-warpage property”), when the compositions are applied to electronic parts which require higher-precision processing. On the other hand, the electronic parts for surface-mounting described in Japanese Patent Application Laid-Open Publication No. 8-143654 (Claims) have good blister resistance, but change in dimension of the molded articles is made large by a heat treatment by solder reflow process, whereby it is difficult to obtain molded article having desired dimensions.

### SUMMARY OF THE INVENTION

One of objects of the invention is to provide a liquid crystalline polymer composition having improved thin-wall moldability, and capable of producing molded articles having lower-warpage property and durability to a practical solder reflow process.

The present invention provides a liquid crystalline polymer composition comprising:

(A) a liquid crystalline polymer including structure units represented by the formula (I), and structure units represented by the formula (II) and/or structure units represented by the formula (III), the structure units represented by the formula (I) being included within the range of 15 to 80% by mol, based on the total structure units [(I)+(II)+(III)]; and

(B) a liquid crystalline polymer (B) including structure units represented by the formula (IV), formula (V) and the formula (VI), each of the structure units represented by the formula (IV), (V) and (VI) being included within the range of 30 to 80% by mol, the range of 10 to 35% by mol and the range of 10 to 35% by mol, respectively, based on the total structure units [(IV)+(V)+(VI)],

the component (B) being included within the range of 5 to 80% by weight based on the total weight of the components (A) and (B).

—OC—Ar₁-0- (I)

—O—Ar₂—O— (II)

—OC—Ar₃—CO— (IIII)

—OC—Ar₄—O— (IV)

—O—Ar₅—X— (V)

—OC—Ar₆—CO— (VI)

wherein Ar₁, Ar₂ and Ar₃ are each 2,6-naphthylene, Ar₄ is 1,4-phenylene, Ar₅ and Ar₆ are independently at least one divalent group selected from the group consisting of 1,3-phenylene, 1,4-phenylene, 4,4′-biphenylylene, 2,6-naphthylene and the following (A-1) to (A-8), and X is —O— or —NH—.

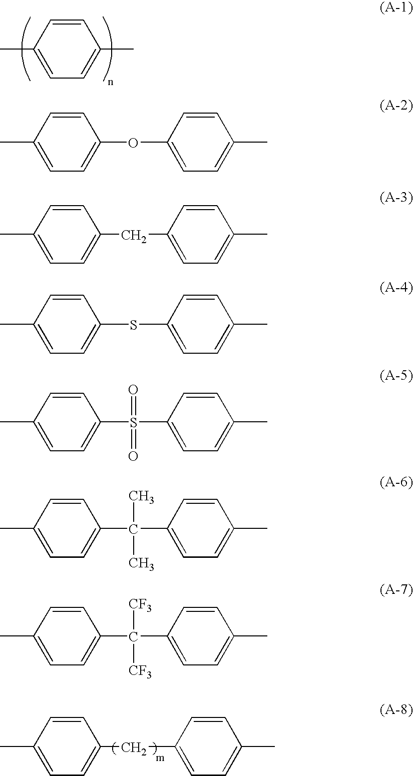

wherein n is an integer of 3 or more, and m is an integer of 2 or more and 6 or less.

The present invention also provides a molded article formed from the liquid crystalline polymer composition mentioned above.

The present invention further provides an electronic part for surface-mounting, which is produced from the molded article.

The liquid crystalline polymer composition of the present invention has thin-wall moldability sufficient for production of a molded article with thin-wall parts. The molded article therefrom has remarkably smaller warpage than those molded from conventionally disclosed compositions, and because the article has small change in dimension even if a heat treatment such as a solder reflow process is performed, the molded article having desired sizes can be produced. That is, the composition of the invention is particularly useful when molded articles having a thin-wall part is produced through a heat treatment. Further, the molded article obtained from the liquid crystalline polymer composition of the invention has improved blister resistance even if the solder reflow process is performed, and thus it is extremely useful for used in electronic parts for surface-mounting.

### BRIEF DESCRIPTION OF THE DRAWINGS

FIG. 1 is a schematic view showing a shape of a metallic mold for measuring a thin-wall flow length used in evaluation of thin-wall flowability in Examples; and

FIG. 2 is a perspective view showing a connector used in connector warpage measurement in Examples.

### DETAILED DESCRIPTION OF THE PREFERRED EMBODIMENTS

A liquid crystalline polymer composition of the present invention comprises:

(A) a liquid crystalline polymer including structure units represented by the formula (I), and structure units represented by the formula (II) and/or structure units represented by the formula (III), the structure units represented by the formula (I) being included within the range of 15 to 80% by mol, based on the total structure units [(I)+(II)+(III)]; and

(B) a liquid crystalline polymer (B) including structure units represented by the formula (IV), formula (V) and the formula (VI), each of the structure units represented by the formula (IV), (V) and (VI) being included within the range of 30 to 80% by mol, the range of 10 to 35% by mol and the range of 10 to 35% by mol, respectively, based on the total structure units [(IV)+(V)+(VI)],

the component (B) being included within the range of 5 to 80% by weight based on the total weight of the components (A) and (B).

—OC—Ar₁-0- (I)

—O—Ar₂—O— (II)

—OC—Ar₃—CO— (III)

—OC—Ar₄—O— (IV)

—O—Ar₅—X— (V)

—OC—Ar₆—CO— (VI)

wherein Ar₁, Ar₂ and Ar₃ are each 2,6-naphthylene, Ar₄ is 1,4-phenylene, Ar₅ and Ar₆ are independently at least one divalent group selected from the group consisting of 1,3-phenylene, 1,4-phenylene, 4,4′-biphenylylene, 2,6-naphthylene and the following (A-1) to (A-8), and X is —O— or —NH—.

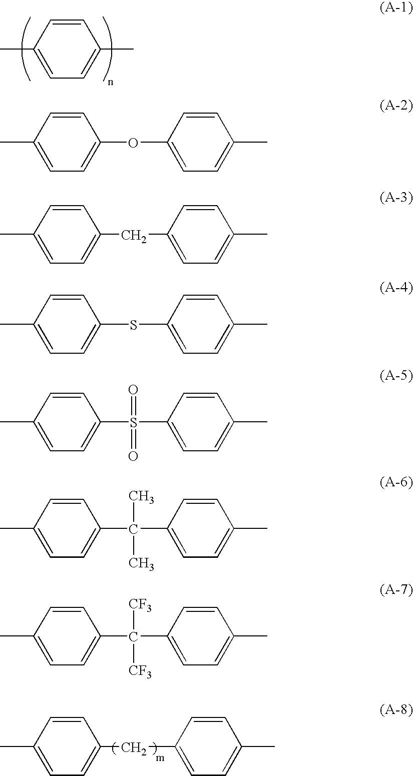

wherein n is an integer of 3 or more, and m is an integer of 2 or more and 6 or less.

### <Liquid Crystalline Polymer (A)>

The liquid crystalline polymer (A) is a polymer forming a molten phase with optical anisotropy, and is characterized by including structure units represented by the formula (I) (hereinafter referred to as “structure units having the formula (I)”), and at least one kind of structure units selected from structure units (II) and structure unit (III), the structure units having the formula (I) being included in a molar percent of 15 to 80% by mol based on the total structure units [(I)+(II)+(III)].

When the percent of the structure units having the formula (I) is less than 15% by mol or more than 80% by mol, the melting point of the liquid crystalline polymer easily increases and, in remarkable cases, insoluble or infusible materials are generated in the liquid crystalline polymer, thus resulting in difficult molding by using general molding machine. On the other hand, when the percent of the structure units having the formula (I) is within the range of 15 to 80% by mol based on the total structure units (I), (II) and (III), the change in dimension of the obtained molded article can be remarkably reduced even if the heat treatment is performed. From the viewpoint of improvement of the liquid crystallinity, the percent of the structure units having the formula (I) is preferably in the range of 30 to 70% by mol, more preferably from 40 to 65% by mol, much more preferably from 50 to 55% by mol.

The structure units having the formula (I) are structure units derived from 2-hydroxy-6-naphthoic acid; structure units represented by the formula (II) (hereinafter referred to as “structure units having the formula (II)”) are structure units derived from 2,6-naphthalenediol; and structure units represented by the formula (III) (hereinafter referred to as “structure units having the formula (III)”) are structure units derived from naphthalene-2,6-dicarboxylic acid.

The flow starting temperature of the liquid crystalline polymer (A) is preferably in the range of 260 to 380° C. from the viewpoint of the improvement of the heat resistance. When the temperature is not less than 280° C. and not more than 360° C., the heat resistance is high and the deterioration by decomposition of the polymer while molding is inhibited. It is much more preferable that the temperature is not less than 300° C. and not more than 350° C.

The flow starting temperature refers to a temperature at the time when the melt viscosity of the liquid crystalline polymer is 4,800 Pa·s (48,000 poises), measured using a capillary rheometer equipped with a dice having an inside diameter of 1 mm and a length of 10 mm, the polymer being extruded from a nozzle at a rate of temperature rise of 4° C./minute under a load of 9.8 MPa (100 kg/cm²). This flow temperature measurement is a parameter showing a molecular weight of a liquid crystalline polymer, which is well known by those skilled in the art (see, for example, “Liquid Crystalline polymer—Synthesis, Molding, and Application—” edited by Naoyuki Koide, pp. 95-105, CMC, published on Jun. 5, 1987).

It is preferable that the liquid crystalline polymer (A) includes structure units represented by the formula (VII) shown below (hereinafter referred to as “structure units having the formula (VII)” and/or structure units represented by the formula (VIII) shown below (hereinafter referred to as “structure units having the formula (VIII),” in addition to the structure units having the formula (I) and the structure units having the formula (II) and/or structure units having the formula (III).

—O—Ar₇—X— (VII)

—OC—Ar₈—CO— (VIII)

wherein Ar₇ and Ar₈ represents, independently, at least one member selected from 1,3-phenylene, 1,4-phenylene and 4,4′-biphenylylene; and X represents —O— or —NH—.

When a part or all of the structure units having the formula (II) is replaced by the structure units having the formula (VII), or a part or all of the structure units having the formula (III) is replaced by the structure units having the formula (VIII), the obtained liquid crystalline polymer (A) tends to have a lower melting point; as a result, molded articles can be obtained at a practical molding temperature. However, liquid crystalline polymers wherein all of the structure units having the formula (II) is replaced by the structure units having the formula (VII), and all of the structure units having the formula (III) is replaced by the structure units having the formula (VIII), in other words, liquid crystalline polymer including no structure units having the formula (II) nor structure units having the formula (III) is not appropriate to the liquid crystalline polymer (A) used in the present invention, because the dimensions of molded articles obtained from such a polymer tend to change significantly after solder reflow process from those before the process.

Examples of the structure unit having the formula (VII) may include structure units derived from resorcin, m-aminophenol, hydroquinone, p-aminophenol, 4,4′-dihydroxybiphenyl or 4-aminobiphenylene-4′-ol. From the view point of reducing cost, the structure units whose starting material is resorcin, hydroquinone, p-aminophenol or 4,4′-hydroxybiphenyl are preferable.

On the other hand, examples of the structure unit having the formula (VIII) may include structure units derived from isophthalic acid, terephthalic acid or 4,4′-biphenyl dicarboxylic acid. From the viewpoint of reducing cost, the structure units derived from isophthalic acid or terephthalic acid are preferable.

The liquid crystalline polymer (A) includes the structure units having the formula (I), and the structure units having the formula (II) and/or structure units having the formula (III), and if necessary, the structure units having the formula (VII) and/or the structure units having the formula (VIII).

Preferable combinations thereof may include the following (A1) to (A6).

(A1) combinations of the structure units having the formula (I), the structure units derived from 4,4′-dihydroxybiphenyl and the structure units having the formula (III);

(A2) combinations of the structure units having the formula (I), the structure units derived from hydroquinone, and the structure units having the formula (III);

(A3) combinations of the structure units having the formula (I), the structure units derived from 4,4′-dihydroxybiphenyl, the structure units having the formula (III), and the structure units derived from terephthalic acid;

(A4) combinations of the structure units having the formula (I), the structure units derived from hydroquinone, the structure units having the formula (III), and the structure units derived from isophthalic acid;

(A5) combinations of the structure units having the formula (I), the structure units having the formula (II), and the structure units derived from telephthalic acid; and

(A6) combinations of the structure units having the formula (I), the structure units having the formula (II) and the structure units derived from isophthalic acid.

Of these, liquid crystalline polymers including both the structure units having the formula (I) and the structure units having the formula (III) are preferable as the liquid crystalline polymer (A) used in the present invention, because such liquid crystalline polymers have lowered melting points, from which liquid crystalline polymer compositions having practical molding temperatures can be obtained. Further, it is preferable that the total percent of the structure units having the formula (I) and the structure units having the formula (III) is 70% by mol or more, based on the total of all structure units [(I)+(II)+(III)+(VII)+(VIII)], more preferably 72% by mol or more, especially 72.5% by mol or more. As described above, the higher the total percent of the structure units having the formula (I) and the structure units having the formula (III), the lower the change in warpage of the obtained molded article when the warpage is measured before and after a solder reflow process.

For producing the liquid crystalline polymer (A), 2-hydroxy-6-naphthoic acid, which derives the structure units having the formula (I), or a derivative capable of forming an ester or amide thereof; a starting material monomer(s) deriving the structure units having the formula (II) and/or structure units having the formula (III), or a derivative capable of forming an ester or amide thereof; and, if necessary, a starting material monomer(s) deriving the structure units having the formula (VII) and/or structure units having the formula (VIII), or a derivative capable of forming an ester or amide thereof are mixed in molar percents similar to copolymerization molar percents of a desired liquid crystalline polymer (A), and the mixture is subjected to polycondensation to give a liquid crystalline polymer. The polycondensation of a liquid crystalline polymer will be described below.

In the liquid crystalline polymer (A), the structure units other than the structure units having the formula (I) are copolymerized with the structure units having the formula (I) to exhibit the liquid crystallinity. The copolymerization molar ratio of these structure units is that [the total of the structure units having the formula (II) and the structure units having the formula (VII)]/[the total of the structure units having the formula (III) and the structure units having the formula (VIII)] is preferably within the range of 85/100 to 100/85. In the liquid crystalline polymer, the total of the structure units having the formula (II) and the structure units having the formula (VII) is substantially equal to the total of the structure units having the formula (III) and the structure units having the formula (VIII) in a copolymerization molar percent. If the polymerization is performed under conditions in which either the former or the later is used in an excess percent, then a polymerization speed can be accelerated, or a liquid crystalline polymer having a reduced degree of polymerization can be obtained.

As described above, the copolymerization molar percent of each structure unit in the liquid crystalline polymer (A) can be controlled, taking into consideration the amounts of the starting material monomers deriving structure units, used in the polymerization, and the condition that the total copolymerization molar percent of the structure units having the formula (II) and the structure units having the formula (VII) is substantially equal to the total copolymerization molar percent of the structure units having the formula (III) and the structure units having the formula (VIII).

The obtained liquid crystalline polymer (A) is decomposed by treating with an amine compound such as ethanolamine, and the resulting decomposed product is analyzed by gas chromatography, liquid chromatography or the like, whereby the structure units forming the liquid crystalline polymer (A) and copolymerization molar percents thereof can be found.

### <Liquid Crystalline Polymer (B)>

The liquid crystalline polymer (B) in the present invention is a liquid crystalline polymer forming a molten phase having optical anisotropy, and is characterized by including structure units represented by the formula (IV) (hereinafter referred to as “structure units having the formula (IV)”); structure units represented by the formula (V) (hereinafter referred to as “structure units having the formula (V)”); and structure units represented by the formula (VI) (hereinafter referred to as “structure units having the formula (VI)”), the molar percent of the structure units having the formula (IV) being from 30 to 80% by mol, based on the total of all structure units [(IV)+(V)+(VI)], the molar percents of the structure units having the formula (V) and the structure units having the formula (VI) being, respectively, from 10 to 35% by mol.

In the structure units having the formula (VI) forming the liquid crystalline polymer (B), Ar₆ is at least one divalent group selected from the group consisting of 1,3-phenylene, 1,4-phenylene, 4,4′-biphenylene, 2,6-naphthalene and (A-1) to (A-8) mentioned above. Of these, like the liquid crystalline polymer (A), structure units forming a fully aromatic polyester or fully aromatic poly(ester-amide) are preferable, from the viewpoint of heat resistance. Specifically, Ar₆ is preferably at least one divalent aromatic group selected from the group consisting of 1,3-phenylene, 1,4-phenylene, 4,4′-biphenylene, 2,6-naphthalene and (A-1) to (A-5).

Structure units forming the liquid crystalline polymer (B) will be described in detailed.

The structure units having the formula (IV) are structure units derived from p-hydroxybenzoic acid, and the copolymerization molar percent thereof is within the above-mentioned range, based on the total of all structure units [(IV)+(V)+(VI)]. When the copolymerization molar percent is less than 30% by mol or more than 80% by mol, the melting point easily increases and, in remarkable cases, insoluble or infusible materials are generated in the polymer, thus resulting in difficult formation of a desired molded article by using general molding machine. On the other hand, when the liquid crystalline polymer (B) including the structure units having the formula (IV) in the above-mentioned copolymerization molar percent is used, molded articles having sufficiently reduced warpage can be obtained.

The copolymerization molar percent of the structure units having the formula (IV) is preferably in a range of 40 to 70% by mol, from the viewpoint of improvement of liquid crystallinity, more preferably from 45 to 65% by mol, much more preferably from 50 to 65% by mol.

The structure units having the formula (V) and the structure units having the formula (VI) express the liquid crystallinity by copolymerization with the structure units having the formula (IV). The relationship between the copolymerization molar fractions of these structure units is that [copolymerization molar fraction of the structure units (V)]/[copolymerization molar fraction of the structure units (VI)] is preferably in the range of 85/100 to 100/85. As described in the item liquid crystalline polymer (A), the structure units forming the liquid crystalline polymer (B) can be controlled by adjusting the amounts of the starting material monomers deriving the structure units, used in the polymerization, and the like.

As the structure units having the formula (V) in the liquid crystalline polymer (B), structure units derived from an aromatic diol are preferable, from the viewpoint of electric properties and inhibition of deformation by water absorption. It is preferable to use at least one monomer selected from the group consisting of 4,4′-dihydroxybiphenyl, hydroquinone, resorcin and 2,6-dihydroxynaphthalene as a starting material monomer, and structure units derived from the aromatic diol listed above are preferable. The liquid crystalline polymer (B) may include two or more kinds of the structure units derived from the aromatic diol.

In particular, it is preferable to use structure units having the formula (Va) described below and/or structure units having the formula (Vb) described below as the structure units (V), because liquid crystalline polymers (B) having more improved heat resistance can be obtained.

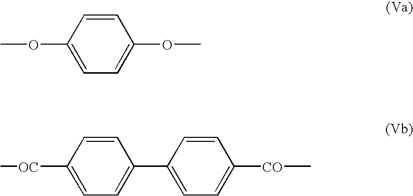

On the other hand, as the structure units having the formula (VI) in the liquid crystalline polymer (B), structure units derived from terephthalic acid, isophthalic acid, 2,6-naphthalene dicarboxylic acid or 4,4′-biphenyl dicarboxylic acid are preferable, because these aromatic dicarboxylic acids are easily obtained. The liquid crystalline polymer (B) may include two or more kinds of the structure units derived from the aromatic dicarboxylic acids.

In particular, it is preferable to use structure units having the formula (VIa) described below and/or structure units having the formula (VIb) described below as the structure units (V), because liquid crystalline polymers (B) having more improved heat resistance can be obtained.

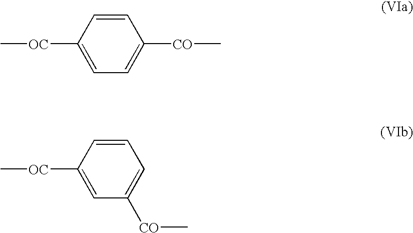

It is preferable that the liquid crystalline polymer (B) has a flow starting temperature of 200 to 360° C., from the viewpoint of improvement of the flowability. Here, the flow starting temperature is measured in the same manner as that of the above-mentioned liquid crystalline polymer (A). The flow starting temperature of the liquid crystalline polymer (B) is preferably within the range of 240 to 350° C., because compositions having good flowability can be obtained, and the decomposition of the polymer can be reduced upon molding. The temperature is more preferably from 260 to 340° C.

For producing the liquid crystalline polymer (B), p-hydroxybenzoic acid, or a derivative capable of forming an ester or amide thereof; the aromatic amine having an aromatic diol and/or hydroxyl group, or a derivative capable of forming an ester or amide thereof; and the aromatic dicarboxylic acid, or a derivative capable of forming an ester or amide thereof are mixed in molar percents similar to copolymerization molar fractions, and the mixture is subjected to polycondensation to give an aromatic polyester or aromatic polyester-amide. A copolymerization molar percent of each structure unit can be controlled in the same manner as above.

The polymerization of the liquid crystalline polymer (A) or the liquid crystalline polymer (B) will be described below.

The polymerization can be performed in known methods such as direct polycondensation methods, ester-change polycondensation methods, melt-polycondensation methods, solution polycondensation methods, solid-phase polymerization methods, or combinations thereof. Preferable examples of the method may include, for example, an ester-change method according to the method described in Japanese Patent Examined Publication No. 47-47870; a production method of a combination of melt-polycondensation method and solid-phase polymerization according to the method described in Japanese Patent Application Laid-Open Publication No. 2005-75843; a method in which the above-mentioned starting materials of the liquid crystalline polymer are polymerized in the presence of a fatty acid anhydride, according to the method described in Japanese Patent Application Laid-Open Publication No. 2002-220444, and the like. Known catalysts for polymerization of polyester can be used, and examples thereof may include metal sale catalysts such as magnesium acetate, stannous acetate, tetrabutyl titanate, lead acetate, sodium acetate, potassium acetate, and antimony trioxide; organic compound catalysts such as N,N-dimethylaminopyridine, and N-methylimidazole; and the like.

Now, a preferable production method of a liquid crystalline polymer will be described below, taking, as an example, a liquid crystalline polymer including the structure units having the formula (I), the structure units having the formula (II) and the structure units having the formula (III) as the liquid crystalline polymer (A). For example, phenolic hydroxyl groups of 2-hydroxy-6-naphthoic acid deriving the structure units having the formula (I) and 2,6-naphthalene diol deriving the structure units having the formula (II) are acylated with an exceed amount of a fatty acid anhydride to give a acylated product, and the resulting aclyated product and naphthalene 2,6-dicarboxylic acid deriving the structure units having the formula (III) are subjected to ester-exchange (polycondensation) and solution polymerization (see Japanese Patent Application Laid-Open Publication Nos. 2002-220444 and 2002-146003).

The resulting liquid crystalline polymer (A) and the liquid crystalline polymer (B), obtained as above, are mixed in a specific mixing ratio to give the liquid crystalline polymer composition of the present invention.

It is necessary that in liquid crystalline polymer composition, a mixing weight percent of the liquid crystalline polymer (B) is from 5 to 80% by weight based on the total weight of the liquid crystalline polymer (A) and the liquid crystalline polymer (B). The mixing weight percent of the liquid crystalline polymer (B) is preferably from 5 to 55% by weight, more preferably from 5 to 45% by weight, much more preferably from 15 to 45% by weight. When the mixing weight percent of the liquid crystalline polymer (B) is within the above-mentioned range, good flowability can be expressed in molded articles having a thin-wall part(s).

The liquid crystalline polymer (A) or the liquid crystalline polymer (B) can reduce the warpage after molding alone, as described above, but when they are mixed in the weight range described above, the warpage can be more reduced than the case where they are used alone. Further, the combination thereof can reduce the change in dimensions measured before and after the solder reflow process. This effect is based on the present inventors' own finding.

It is preferable to select the liquid crystalline polymer (A) and the liquid crystalline polymer (B) so that the flow starting temperature of the liquid crystalline polymer (A) is not less than 5° C. higher than that of the liquid crystalline polymer (B), from the viewpoint of remarkable improvement of the flowability of the liquid crystalline polymer composition.

As described above, the liquid crystalline polymer composition of the present invention including the liquid crystalline polymer (A) and the liquid crystalline polymer (B) can be obtained. The liquid crystalline polymer composition may include at least one filler selected from the group consisting of organic fillers and inorganic fillers so long as the effects intended by the invention are not impaired. When the fillers are mixed therewith, compositions giving molded articles having more reduced warpage can be obtained.

In particular, since the use of the filler may reduce the mechanical strength, the amount of the filler added is preferably 1 to 80 parts by weight, based on 100 parts by weight of the liquid crystalline polymer (A) and the liquid crystalline polymer (B), more preferably from 5 to 65 parts by weight, much more preferably from 20 to 55 parts by weight.

As such a filler, fibrous, granular, or plate organic or inorganic fillers may be added. Examples of the fibrous filler may include glass fiber, as best fiber, silica fiber, silica-alumina fiber, alumina fiber, zirconia fiber, boron nitride fiber, silicon nitride fiber, boron fiber, potassium titanate fiber, fiber of silicate salt such as wollastonite, magnesium sulfate fiber and aluminum borate fiber, as well as inorganic fibrous materials including fibrous materials of metal such as stainless steel, aluminum, titanium, copper and brass. Typical fibrous filler is the glass fiber. Fibrous organic materials having a high melting point such as polyamides, fluororesins, polyester resins, and acrylic resins can also be used.

On the other hand, examples of the granular filler may include carbon black, graphite, silica, quartz powder, glass beads, milled glass fiber, glass balloon, glass powder, silicate salts such as calcium silicate, aluminum silicate, kaolin, clay, diatom earth, and wollastonite; metal oxides such as ferric oxide, titanium oxide, zinc oxide, antimony trioxide, and alumina; metal carbonates such as calcium carbonate and magnesium carbonate; metal sulfate such as calcium sulfate and barium sulfate; ferrites, silicon carbide, silicon nitride, boron nitride, various metal powders, and the like.

Examples of the plate filler may include mica, glass flake, talk, various metal foils, and the like.

Examples of the organic filler may include heat-resistant and high-strength synthetic fibers such as aromatic polyester fibers, liquid crystalline polymer fibers, aromatic polyamides and polyimide fibers.

The inorganic fillers and/or organic fillers may be used alone or as a combination thereof. The combination of the fibrous filler and the granular or plate filler is particularly preferable because such a combination expresses all of high mechanical strength, dimensional accuracy and electric properties.

The liquid crystalline polymer composition of the invention can be produced without any particular limitation, and may be produced in any known method, using the liquid crystalline polymer (A) and the liquid crystalline polymer (B), and if necessary, the inorganic filler and/or organic filler as starting materials.

Specifically, examples of the method may include:

1) a method in which fillers are added separately to the liquid crystalline polymer (A) and the liquid crystalline polymer (B), and the mixtures are blended in an extruder;

2) a method in which fillers are added separately to the liquid crystalline polymer (A) and the liquid crystalline polymer (B), and the mixtures are dry-blended in the state of pellets to directly form; and

3) a method in which two kinds of the liquid crystalline polymers having no filler and a given amount of a filler are mixed in an extruder. It is not necessary to use an extruder as a mixer, and kneaders and the like may be used.

The liquid crystalline polymer composition of the invention can be produced by using the methods described above. Also, the composition may include additives in addition to the filler listed above so long as the effects obtained by the filler are not impaired. Further, the composition may include other resins, within the range where the mechanical properties and heat resistance of the liquid crystalline polymer composition can be maintained. Examples of such additives may include known coupling agents, antioxidants, ultraviolet absorbers, heat-stabilizers, coloring agents, and the like.

The liquid crystalline polymer compositions of the invention have good flowability upon melting, and do not require relatively high temperatures when they are molded. Consequently, the compositions can be subjected to injection molding, extrusion or compression molding even if molding machines having a specific structure are not used, and can give various three-dimensional molded articles, especially molded articles having a thin-wall part. The molded articles can be extremely suitably used for electronic parts for surface-mounting.

It is preferable that the molded articles from the liquid crystalline polymer compositions of the invention obtained as above, have a deflection temperature under load of 220° C. or more, since the change in dimension of the molded article can be more highly prevented in a heat treatment by solder reflow process within the above-mentioned deflection temperature range. In order to obtain higher heat resistance, the deflection temperature is preferably 230° C. or more, more preferably 250° C. or more.

Here, the deflection temperature under load refers to a value obtained by producing a test piece with a length of 127 mm, a width of 12.7 mm and a thickness of 6.4 mm through an injection molding, and measuring the test piece according to ASTM D648 under a load of 18.6 kg/cm².

Molded articles having a deflection temperature under load of 220° C. or more can be obtained by adjusting the deflection temperatures under load of both of the liquid crystalline polymer (A) and the liquid crystalline polymer (B) to 220° C. or more.

The liquid crystalline polymer compositions of the invention include two kinds of the specific liquid crystalline polymers, and only such a liquid crystalline polymer compositions can have high moldability (flowability); can give thin-wall molded articles having high blister resistance, heat resistance and low warpage; and can give remarkably low change in dimension to the molded articles even if the composition is subjected to a heat treatment by solder reflow process. The compositions of the invention are preferably applied to electronic parts for surface-mounting, and such advantages obtained in the invention cannot be easily obtained from resin compositions including a conventionally disclosed liquid crystalline polymer.

Among the molded articles produced from the liquid crystalline polymer composition of the invention are particularly suitable for used in connectors for printed board, plugs for IC/LSI, connector for a card, or square type connectors from among various electronic parts for surface-mounting.

As described above, although the liquid crystalline polymer resin composition of the invention can give molded articles suitable for use in electronic parts for surface-mounting, the composition, of course, can be processed into fibrous molded articles, filmy molded articles, and the like.

Examples of the molded article may include, in addition to electric or electronic parts other than the electronic parts for surface-mounting described above,

parts of home electric appliances such as VTR, televisions, clothes irons, air conditioners, stereo systems, vacuum cleaners, refrigerators, rice cookers, and lighting apparatuses;

parts of a light apparatus such as lamp reflectors, and lamp holders;

parts of an acoustic product such as compact discs, laser discs, and speakers;

parts of a communication device such as ferrules for an optic cable, parts of a telephone set, parts of a facsimile machine, and modems;

parts of a copying machine or printer-related parts such as separation claws and heater holders;

machine parts such as impellers, fan gears, gears, bearings, motor parts and cases;

automobile parts such as mechanical components for automobiles, engine parts, parts in an engine room, electrical components and interior parts;

kitchen utensils such as microwave-safe pots and heat-resistant dishes;

materials for heat insulation or sound insulation such as floor covers and wall materials, base materials such as beam and pillars, construction materials such as roof materials, or materials for civil engineering and construction;

parts for an airplane, spacecraft or spacecraft;

members used in a radiation facility such as atomic reactors, members used in marine facilities, tools for washing, parts for optical devices, valves, pipes, nozzles, filters, membranes, parts for medical devices and medical materials, parts for sensors, supplies for sanitary, sports goods, leisure goods, and the like. The composition of the invention can be used for these applications.

The invention being thus described, it will be apparent that the same may be varied in many ways. Such variations are to be regarded as within the spirit and scope of the invention, and all such modifications as would be apparent to one skilled in the art are intended to be within the scope of the following claims.

The entire disclosure of the Japanese Patent Application No. 2006-165751 filed on Jun. 15, 2006, including specification, claims, drawings and summary, are incorporated herein by reference in their entirety.

### EXAMPLES

The present invention is described in more detail by following Examples, which should not be construed as a limitation upon the scope of the present invention.

The properties of the resin such as flow starting temperature, tensile strength, impact strength, deflection temperature under load, flexural strength, and shrinkage of molded article were measured as follows:

### [Method for Measuring Flow Starting Temperature]

Flow starting temperature was measured with the use of a flow tester (CFT-500 type, manufactured by Shimadzu Corporation). Specifically, first, the sample of about 2 g was filled in the capillary type rheometer which was equipped with the die of 1 mm in inside diameter and 10 mm in length. The flow starting temperature was then designated as a temperature at which the melt viscosity of the liquid crystalline polymer showed 4800 Pas (48000 poise), when the polymer was extruded from a nozzle at a rate of temperature rise of 4° C./minute under a load of 9.8 MPa (100 kg/cm²).

### [Deflection Temperature under Load]

Using a test sample with a length of 127 mm, a width of 12.7 mm, and a thickness of 6.4 mm, it was measured according to ASTM D648 under a load of 18.6 kg/cm².

### [Foaming Test in Solder (Blister Resistance in Solder)]

A JIS K 71131 (½) size dumbbell×1.2 mmt was immersed in H60A solder (stannum: 60%, lead: 40%) at 260° C. for 60 seconds, and whether or not the molded article was foamed or swollen was confirmed.

### [Connector Warpage Measurement]

Using a metallic mold shown in FIG. 2 (wall thickness at end parts: 0.15 mm), test samples were made through an injection molding machine (UH-1000 type made by Nissei Plastic Industrial Co., Ltd.) at an injection rate of 200 mm/sec under a holding pressure of 50 MPa. The molded article, which was taken out, was put on a platen, a height of the article from the platen was measured every 1 mm from a gate side to the opposite side thereof with a micrometer, and as to the measured values, each displacement from a value measured at a standard surface, which is a surface at the gate side, was calculated. From the obtained displacements, a warpage shape was found according to a least-square method program, and the maximal value was considered as a warpage value of each molded article. A mean value of 5 molded articles is shown as the warpage value.

Subsequently, the sample whose warpage had been measured was put into an oven having an inner temperature of 260° C., and a heat treatment was performed for 90 seconds. After the heat treatment, the sample was taken out of the oven, the warpage values thereof were measured in the same manner as above. The obtained values were warpage value after heat treatment. The change of the warpage values measured before and after the heat treatment is a parameter showing a change in dimension by the heat treatment.

### [Thin-Wall Flowability]

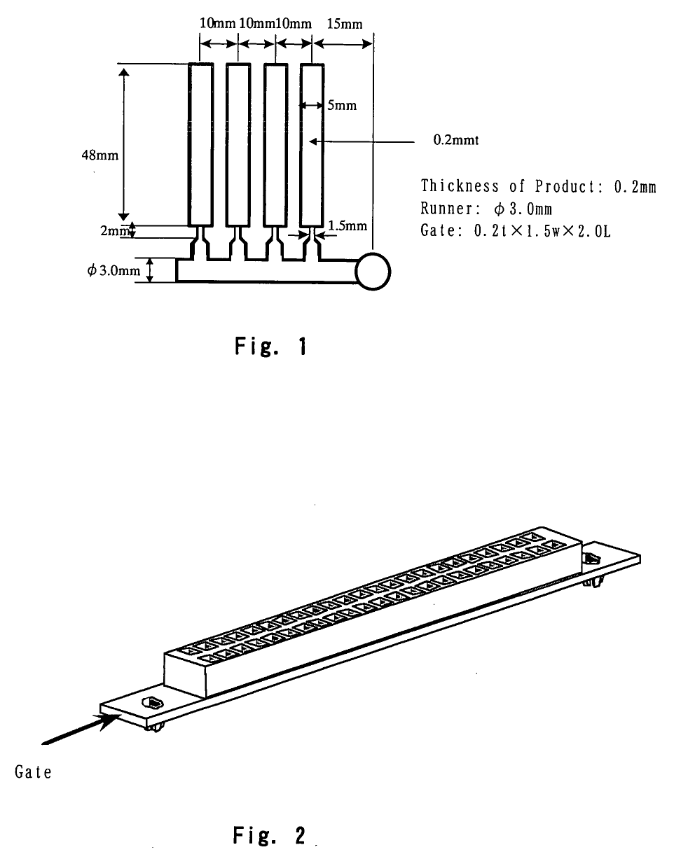

Using a thin-wall flow-length metallic mold having 4 cavities with a thickness in a product part of 0.2 mm, shown in FIG. 1, a sample was molded at a measuring temperature of 350° C. through an injection molding machine (PS 10 E1ASE type made by Nissei Plastic Industrial Co., Ltd.) at an injection rate of 95% under an injection pressure of 900 kg/cm². The lengths of 4 cavity parts in the molded article were measured, and the mean value thereof is shown as the thin-wall flow length.

### Synthetic Example 1

To a reactor equipped with a stirring device, a torque meter, a nitrogen gas inlet tube, a thermometer, and a reflux condenser were added 2-hydroxy-6-naphthoic acid 987.95 g (5.25 mol), 4,4′-dihydroxybiphenyl 486.47 g (2.612 mol), 2,6-naphthalene dicarboxylic acid 513.45 g (2.375 mol), acetic anhydride 1174.04 g (11.5 mol) and 1-methylimidazol 0.194 g as a catalyst, and the mixture was stirred at room temperature for 15 minutes. Then, the temperature of the mixture was elevated while stirring, and the stirring was continued for further 1 hour when the inner temperature reached 145° C., while keeping the temperature, and the catalyst, 1-methylimidazole 5.83 g was further added thereto.

The inner temperature was elevated from 145° C. to 310° C. over 3 hours and 30 minutes while a distilling by-product, acetic acid and unreacted acetic anhydride were distilled away. The temperature of the reaction mixture was kept at the same temperature for 2 hours to give an aromatic polyester. The obtained aromatic polyester was cooled to room temperature, and was pulverized through a pulverizer to give an aromatic polyester power having a particle size of about 0.1 to 1 mm.

The flow starting temperature of this liquid crystal aromatic polyester powder was measured by using a flow tester, and it was found that the temperature was 273° C.

The temperature of the obtained powder was elevated from 25° C. to 250° C. over 1 hour and then from 250° C. to 300° C. over 10 hours, and was kept at the same temperature over 12 hours, thereby performing solid-phase polymerization. Then, the powder after the solid-phase polymerization was cooled down to give a powdery liquid crystalline polymer, which is referred to as “liquid crystalline polymer (A)-1.”

The liquid crystalline polymer (A)-1 had a flow starting temperature of 324° C., and a substantial copolymerization molar fraction of the structure units of 52.5% by mol: 23.75% by mol: 23.75% by mol in the structure units having the formula (I): the structure units having the formula (III): the structure units having the formula (VII). Also, the liquid crystalline polymer (A)-1 had a copolymerization molar fraction of [the structure units (I)+the structure units (III)] of 76.25% by mol based on the total structure units.

### Synthetic Example 2

To the same reactor as used in Synthetic Example 1 were added 2-hydroxy-6-naphthoic acid 1034.99 g (5.5 mol), hydroquinone 272.52 g (2.475 mol), 2,6-naphthalenedicarboxylic acid 378.33 g (1.75 mol), terephthalic acid 83.07 g (0.5 mol), acetic anhydride 1226.87 g (11.9 mol) and 1-methylimidazole 0.17 g as a catalyst, and the mixture was stirred at room temperature for 15 minutes. Then, the temperature of the mixture was elevated while stirring, and the stirring was continued for further 1 hour when the inner temperature reached 145° C., while keeping the temperature.

The inner temperature was elevated from 145° C. to 310° C. over 3 hours and 30 minutes while a distilling by-product, acetic acid and unreacted acetic anhydride were distilled away. The temperature of the reaction mixture was kept at the same temperature for 3 hours to give a liquid crystalline polymer. The liquid crystalline polymer was cooled to room temperature, and was pulverized through a pulverizer to give a liquid crystalline polymer power (prepolymer) having a particle size of about 0.1 to 1 mm.

The flow starting temperature of this prepolymer was measured by using a flow tester, and it was found that the temperature was 267° C.

The temperature of the obtained powder was elevated from is 25° C. to 250° C. over 1 hour and then from 250° C. to 310° C. over 10 hours, and was kept at the same temperature over 5 hours, thereby performing solid-phase polymerization. Then, the powder after the solid-phase polymerization was cooled down to give a powdery liquid crystalline polymer, which is referred to as “liquid crystalline polymer (A)-2.”

The liquid crystalline polymer (A)-2 had a flow starting temperature of 333° C., and a substantial copolymerization molar fraction of the structure units of 55.0% by mol: 17.5% by mol: 22.5% by mol: 5.0% by mol in the structure units having the formula (I): the structure units having the formula (III): the structure units having the formula (VII): the structure units having the formula (VIII). Also, the liquid crystalline polymer (A)-2 had a copolymerization molar fraction of [the structure units (I)+the structure units (III)] of 72.5% by mol based on the total structure units.

### Synthetic Example 3

In the same reactor as used in Synthetic Example 1 were stirred p-hydroxybenzoic acid 911 g (6.6 mol), 4,4′-dihydroxybiphenyl 409 g (2.2 mol), isophthalic acid 91 g (0.55 mol), terephthalic acid 274 g (1.65 mol) and acetic anhydride 1235 g (12.1 mol). Then, 1-methylimidazole 0.17 g was added thereto, and the inside of the reactor was sufficiently replaced with nitrogen gas. Then, the temperature was elevated up to 150° C. over 15 minutes under nitrogen gas stream, and the mixture was refluxed for 1 hour while keeping the temperature at 150° C. After that, 1-methylimidazole 1.7 g was added thereto, the temperature was elevated to 320° C. over 2 hours and 50 minutes while a distilling by-product acetic acid and unreacted acetic anhydride were distilled away, and the reaction mixture was taken out of the reactor when the torque began to increase, which was considered as the end point of the reaction.

Subsequently, powdery prepolymer (particle size: about 0.1 mm to about 1 mm) was obtained in the same manner as in Synthetic Example 1. The flow starting temperature was 257° C.

The temperature of the obtained powder was elevated from 25° C. to 250° C. over 1 hour and then from 250° C. to 285° C. over 5 hours, and was kept at the same temperature over 3 hours, thereby performing solid-phase polymerization. Then, the powder after the solid-phase polymerization was cooled down to give a powdery liquid crystalline polymer, which is referred to as “liquid crystalline polymer (B)-1.”

The liquid crystalline polymer (B)-1 had a flow starting temperature of 327° C., and a substantial copolymerization molar fraction of the structure units of 60.0% by mol: 20.0% by mol: 20.0% by mol in the structure units having the formula (IV): the structure units having the formula (V): the structure units having the formula (VI).

### Synthetic Example 4

In a reactor equipped with a stirring device, a torque meter, a nitrogen gas inlet tube, a thermometer, and a reflux condenser were stirred p-hydroxybenzoic acid 995 g (7.2 mol), 4,4′-dihydroxybiphenyl 447 g (2.4 mol), isophthalic acid 159 g (0.96 mol), terephthalic acid 239 g (1.44 mol) and acetic anhydride 1348 g (13.2 mol). Then, 1-methylimidazole 0.18 g was added thereto, and the inside of the reactor was sufficiently replaced with nitrogen gas. Then, the temperature was elevated up to 150° C. over 15 minutes under nitrogen gas stream, and the mixture was refluxed for 1 hour while keeping the temperature at 150° C. After that, 1-methylimidazole 5.4 g was added thereto, the temperature was elevated to 320° C. over 2 hours and 50 minutes while a distilling by-product acetic acid and unreacted acetic anhydride were distilled away, and the reaction mixture was taken out of the reactor when the torque began to increase, which was considered as the end point of the reaction.

Subsequently, powdery prepolymer (particle size: about 0.1 mm to about 1 mm) was obtained in the same manner as in Synthetic Example 1. The flow starting temperature was 242° C.

The temperature of the obtained powder was elevated from 25° C. to 200° C. over 1 hour and then from 200° C. to 242° C. over 5 hours, and was kept at the same temperature over 3 hours, thereby performing solid-phase polymerization. Then, the powder after the solid-phase polymerization was cooled down to give a powdery liquid crystalline polymer, which is referred to as “liquid crystalline polymer (B)-2.”

The liquid crystalline polymer (B)-2 had a flow starting temperature of 288° C., and a substantial copolymerization molar fraction of the structure units of 60.0% by mol: 20.0% by mol: 20.0% by mol in the structure units having the formula (IV): the structure units having the formula (V): the structure units having the formula (VI).

### Synthetic Example 5

To the same reactor as used in Synthetic Example 1 were added p-hydroxybenzoic acid 828.72 g (6.00 mol), hydroquinone 330.33 g (3.30 mol), 2,6-naphthalene dicarboxylic acid 648.57 g (3.00 mol), acetic anhydride 1408.84 g (13.8 mol) and 1-methylimidazole 0.181 g as a catalyst, and the mixture was stirred at room temperature for 15 minutes. Then, the temperature of the mixture was elevated while stirring, and the stirring was continued for further 30 minutes when the inner temperature reached 145° C., while keeping the temperature.

The inner temperature was elevated from 145° C. to 310° C. over 3 hours while a distilling by-product, acetic acid and unreacted acetic anhydride were distilled away. After that, 1-methylimidazole 1.808 g was further added thereto, and the temperature was kept at the same temperature for 1 hour to give a liquid crystalline polymer. The obtained liquid crystalline is polymer was cooled to room temperature, and was pulverized through a pulverizer to give a liquid crystalline polymer power (a particle size: about 0.1 mm to 1 mm).

The temperature of the obtained powder was elevated from 25° C. to 250° C. over 1 hour and then from 250° C. to 305° C. over 10 hours, and was kept at the same temperature over 4 hours, thereby performing solid-phase polymerization. Then, the powder after the solid-phase polymerization was cooled down to give a powdery liquid crystalline polymer, which is referred to as “liquid crystalline polymer (B)-3”.

The liquid crystalline polymer (B)-3 had a flow starting temperature of 327° C., and a substantial copolymerization molar fraction of the structure units of 50.0% by mol: 25.0% by mol: 25.0% by mol in the structure units having the formula (IV): the structure units having the formula (V): the structure units having the formula (VI).

### Synthetic Example 6

To the same reactor as used in Synthetic Example 1 were added 2-hydroxy-6-naphthoic acid 903.26 g (4.80 mol), p-hydroxybenzoic acid 27.62 g (0.20 mol), 4,4′-dihydroxybiphenyl 465.53 g (2.50 mol), terephthalic acid 415.33 g (2.50 mol), acetic anhydride 1122.99 g (11.0 mol) and 1-methylimidazole 0.18 g as a catalyst, and the mixture was stirred at room temperature for 15 minutes. Then, the temperature of the mixture was elevated while stirring, and the stirring was continued for further 1 hour when the inner temperature reached 145° C., while keeping the temperature.

The inner temperature was elevated from 145° C. to 310° C. over 3 hours and 30 minutes while a distilling by-product, acetic acid and unreacted acetic anhydride were distilled away. The temperature was kept at the same temperature for 3 hours to give a liquid crystalline polymer. The obtained liquid crystalline polymer was cooled to room temperature, and was pulverized through a pulverizer to give a liquid crystalline polymer power having a particle size of about 0.1 mm to 1 mm (prepolymer).

The flow starting temperature of this prepolymer was measured by using a flow tester, and it was found that the temperature was 265° C.

The temperature of the obtained powder was elevated from 25° C. to 250° C. over 1 hour and then from 250° C. to 320° C. over 10 hours, and was kept at the same temperature over 5 hours, thereby performing solid-phase polymerization. Then, the powder after the solid-phase polymerization was cooled down to give a powdery liquid crystalline polymer, which is referred to as “liquid crystalline polymer (C)-1.”

The obtained liquid crystalline polymer (C)-1 had a flow starting temperature of 337° C.

### Examples 1 to 4 and Comparative Examples 1 to 8

The liquid crystalline polymers obtained in Synthetic Examples 1 to 6 were blended in a ratio shown in Table 1. The blended liquid crystalline polymers and chopped glass fiber (CS03 JAPX-1 made by Asahi Fiber Glass Co., Ltd.) were supplied into a twin-screw extruder through the first feeder and the side feeder, respectively, in ratios shown in Table 1 or 2, and the mixture was kneaded to produce pellets. The obtained pellets were molded into various test samples by using an injection molding machine (PS40 EASE made by Nissei Plastic Industrial Co., Ltd.), and physical properties were measured by using the test samples.

Similarly, after the liquid crystalline polymers were blended in a ratio shown in Table 2, the blended liquid crystalline polymers and milled glass fiber (EFH 75-01 made by Central Glass Co., Ltd.) were supplied into a twin-screw extruder through the first feeder and the side feeder, respectively, in ratios shown in Table 2, and the mixture was kneaded to produce pellets. The obtained pellets were molded into various test samples by using an injection molding machine (PS40 EASE made by Nissei Plastic Industrial Co., Ltd.), and physical properties were measured by using the test samples.

TABLE 1

| | Example | | |
|---|---|---|---|
| | 1 | 2 | 3 |
| Liquid crystalline | Liquid | Liquid | Liquid |
| polymer Kind 1 | crystalline | crystalline | crystalline |
| | polymer (A)-1 | polymer (A)-1 | polymer (A)-1 |
| Liquid crystalline | Liquid | Liquid | Liquid |
| polymer Kind 2 | crystalline | crystalline | crystalline |
| | polymer (B)-1 | polymer (B)-2 | polymer (B)-2 |
| Liquid crystalline | 55.25 | 42.25 | 35.75 |
| polymer Kind 1 | | | |
| (part by weight) | | | |
| Liquid crystalline | 9.75 | 22.75 | 29.25 |
| polymer Kind 2 | | | |
| (part by weight) | | | |
| The percentage (%) by | 85% | 65% | 55% |
| weight of the liquid | | | |
| crystalline polymer | | | |
| (A) based on the total | | | |
| weight of liquid | | | |
| crystalline polymers | | | |
| Chopped glass fiber | 35 | 35 | 35 |
| (part by weight) | | | |
| Difference in flow | 36 | 36 | 36 |
| starting temperature | | | |
| between the liquid | | | |
| crystalline polymer | | | |
| (A) and the liquid | | | |
| crystalline polymer | | | |
| (B), (A) − (B) (° C.) | | | |
| Granulating | 340 | 340 | 340 |
| temperature (° C.) | | | |
| Molding temperature | 350 | 350 | 350 |
| (° C.) | | | |
| Deflection | 282 | 264 | 246 |
| temperature under load | 282 | 264 | 246 |
| (° C.) | | | |
| Foaming test in solder | None | None | None |
| (foaming, blister or | | | |
| no blister) | | | |
| Warpage of molded | 0.036 | 0.032 | 0.038 |
| article (mm) (before | | | |
| heat treatment) | | | |
| Warpage of molded | 0.050 | 0.044 | 0.062 |
| article (mm) (after | | | |
| heat treatment) | | | |
| Thin-wall flowability | 14.8 | 17.0 | 18.6 |
| (mm) (0.2 mm at | | | |
| 350° C.) | | | |

TABLE 2

| | Comparative Example | | | | | | |
|---|---|---|---|---|---|---|---|
| | 1 | 2 | 3 | 4 | 5 | 6 | 7 |
| Liquid | Liquid | Liquid | Liquid | Liquid | Liquid | Liquid | Liquid |
| crystalline | crystalline | crystalline | crystalline | crystalline | crystalline | crystalline | crystalline |
| polymer Kind 1 | polymer | polymer | polymer | polymer | polymer | polymer | polymer |
| | (A)-1 | (A)-2 | (B)-1 | (B)-2 | (B)-3 | (C)-1 | (B)-1 |
| Liquid | None | None | None | None | None | None | Liquid |
| crystalline | | | | | | | crystalline |
| polymer Kind 2 | | | | | | | polymer |
| | | | | | | | (B)-2 |
| Liquid | 65 | 65 | 65 | 65 | 65 | 65 | 35.75 |
| crystalline | | | | | | | |
| polymer Kind | | | | | | | |
| 1 (part by | | | | | | | |
| weight) | | | | | | | |
| Liquid | None | None | None | None | None | None | 29.25 |
| crystalline | | | | | | | |
| polymer Kind | | | | | | | |
| 2 (part by | | | | | | | |
| weight) | | | | | | | |
| Chopped glass | 35 | 35 | 35 | 35 | 35 | 35 | 35 |
| fiber (part | | | | | | | |
| by weight) | | | | | | | |
| Granulating | 340 | 340 | 340 | 300 | 340 | 350 | 340 |
| temperature | | | | | | | |
| (° C.) | | | | | | | |
| Molding | 350 | 350 | 350 | 320 | 350 | 380 | 350 |
| temperature | | | | | | | |
| (° C.) | | | | | | | |
| Deflection | 310 | 262 | 282 | 241 | 283 | 326 | 266 |
| temperature | | | | | | | |
| under load | | | | | | | |
| (° C.) | | | | | | | |
| Foaming test | None | None | None | Detected | None | None | None |
| in solder | | | | | | | |
| (foaming, | | | | | | | |
| blister or no | | | | | | | |
| blister) | | | | | | | |
| Warpage of | 0.047 | 0.045 | 0.073 | 0.055 | 0.059 | 0.077 | 0.061 |
| molded | | | | | | | |
| article (mm) | | | | | | | |
| (before heat | | | | | | | |
| treatment) | | | | | | | |
| Warpage of | 0.074 | 0.071 | 0.102 | 0.073 | 0.092 | 0.133 | 0.087 |
| molded | | | | | | | |
| article (mm) | | | | | | | |
| (after heat | | | | | | | |
| treatment) | | | | | | | |
| Thin-wall | 13.1 | 11.0 | 8.9 | 15.0 | 13.3 | 9.5 | 12.1 |
| flowability | | | | | | | |
| (mm) (0.2 mm | | | | | | | |
| at 350° C.) | | | | | | | |

In Examples 1 to 3, the obtained molded articles gave good results in the thin-wall moldability (thin-wall flowability) and the foaming test in solder (blister resistance), and had low warpages before and after heat treatment. On the other hand, in Comparative Examples 1 and 2 in which only the liquid crystalline polymer (A) was used, in Comparative Examples 4 and in which only the liquid crystalline polymer (B) was used, and in Comparative Example 6 in which the liquid crystalline polymer obtained in Synthetic Example 6, the obtained molded article had large change in warpage value between before and after the heat treatment. In Comparative Example 4, the blister resistance worsened too. In Comparative Example 7 in which two kinds of the liquid crystalline polymers (B) were mixed, the obtained molded article had a large warpage. In Comparative Examples 1 to 7, all of the molded articles had insufficient thin-wall flowability.

TABLE 3

| | | Comparative |
|---|---|---|
| | Example 4 | Example 8 |
| Liquid crystalline polymer | Liquid crystalline | Liquid crystalline |
| Kind 1 | polymer (A)-2 | polymer (B)-1 |
| Liquid crystalline polymer | Liquid crystalline | Liquid crystalline |
| Kind 2 | polymer (B)-1 | polymer (B)-2 |
| Liquid crystalline polymer | 33 | 33 |
| Kind 1 (part by weight) | | |
| Liquid crystalline polymer | 27 | 27 |
| Kind 2 (part by weight) | | |
| The percentage (%) by weight of | 55 | — |
| the liquid crystalline polymer | | |
| (A) based on the total weight | | |
| of liquid crystalline polymers | | |
| Milled glass fiber (part by | 40 | 40 |
| weight) | | |
| Difference in flow starting | 6 | — |
| temperature between the liquid | | |
| crystalline polymer (A) and the | | |
| liquid crystalline polymer | | |
| (B), (A) − (B) (° C.) | | |
| Granulating temperature (° C.) | 340 | 340 |
| Molding temperature (° C.) | 350 | 350 |
| Deflection temperature under | 239 | 251 |
| load (° C.) | | |
| Foaming test in solder | None | None |
| (foaming, blister or no | | |
| blister) | | |
| Warpage of molded article (mm) | 0.049 | 0.052 |
| (before heat treatment) | | |
| Warpage of molded article (mm) | 0.057 | 0.074 |
| (after heat treatment) | | |
| Thin-wall flowability (mm) | 14.6 | 11.0 |
| (0.2 mm at 350° C.) | | |

When comparing Example 4 to Comparative Example 8, it was found that the liquid crystalline polymer composition obtained in Example 4 had better thin-wall flowability and small change in warpage value between before and after heat treatment.

1. A liquid crystalline polymer composition comprising:
(A) a liquid crystalline polymer including structure units represented by the formula (I), and structure units represented by the formula (II) and/or structure units represented by the formula (III), the structure units represented by the formula (I) being included within the range of 15 to 80% by mol, based on the total structure units [(I)+(II)+(III)]; and
(B) a liquid crystalline polymer (B) including structure units represented by the formula (IV), formula (V) and the formula (VI), each of the structure units represented by the formula (IV), (V) and (VI) being included within the range of 30 to 80% by mol, the range of 10 to 35% by mol and the range of 10 to 35% by mol, respectively, based on the total structure units [(IV)+(V)+(VI)], the component (B) being included within the range of 5 to 80% by weight based on the total weight of the components (A) and (B).
—OC—Ar₁-0- (I)
—O—Ar₂—O— (II)
—OC—Ar₃—CO— (III)
—OC—Ar₄—O— (IV)
—O—Ar₅—X— (V)
—OC—Ar₆—CO— (VI)
wherein Ar₁, Ar₂ and Ar₃ are each 2,6-naphthylene, Ar₄ is 1,4-phenylene, Ar₅ and Ar₆ are independently at least one divalent group selected from the group consisting of 1,3-phenylene, 1,4-phenylene, 4,4′-biphenylylene, 2,6-naphthylene and the following (A-1) to (A-8), and X is —O— or —NH—. 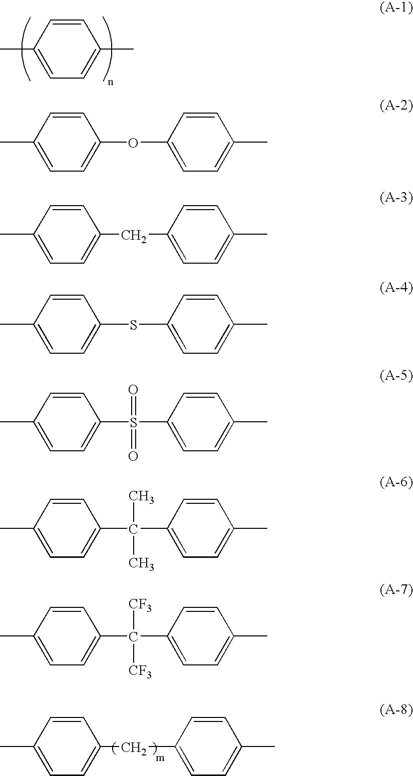
wherein n is an integer of 3 or more, and m is an integer of 2 or more and 6 or less.

2. The liquid crystalline polymer composition according to claim 1, wherein the liquid crystalline polymer (A) further comprises structure units represented by the formula (VII) and/or structure units represented by the formula (VIII).
—O—Ar₇—X— (VII)
—OC—Ar₈—CO— (VIII)
wherein Ar₇ and Ar₈ are, respectively, at least one group selected from 1,3-phenylene, 1,4-phenylene and 4,4′-biphenylylene, and X is —O— or —NH—.

3. The liquid crystalline polymer composition according to claim 1, wherein the liquid crystalline polymer (A) contains the structure units represented by the formula (I) and the structure units represented by the formula (III), the total amount of the structure units represented by the formulas (I) and (III) being within the range of 70% by mol or more based on the total structure units (I), (II) and (III).

4. The liquid crystalline polymer composition according to claim 1, wherein the structure units represented by the formula (V) forming the liquid crystalline polymer (B) are structure units represented by the formula (Va) and/or the formula (Vb); and the structure units represented by the formula (VI) are structure units represented by the formula (Vla) and/or the formula (Vlb).

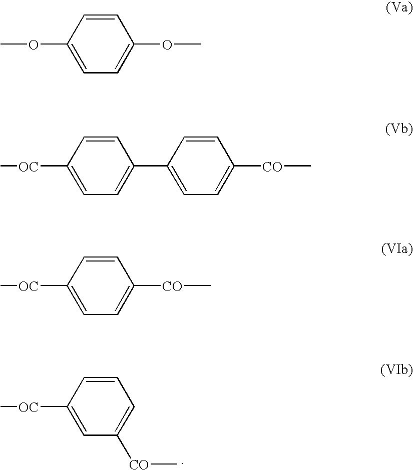

5. The liquid crystalline polymer composition according to claim 1, wherein the liquid crystalline polymer (A) and the liquid crystalline polymer (B) satisfy the following requirements (1) and (2):
(1) the flow starting temperature of the liquid crystalline polymer (A) being not less than 5° C. higher than the flow starting temperature of the liquid crystalline polymer (B); and
(2) the amount of the component (B) is within the range of 15 to 45% by weight, based on the total weight of the components (A) and (B).

6. The liquid crystalline polymer composition according to claim 1, which further comprises at least one filler selected from the group consisting of organic fillers and inorganic fillers, in addition to the liquid crystalline polymer (A) and the liquid crystalline polymer (B).

7. A molded article formed from the liquid crystalline polymer composition of claim 1.

8. The molded article according to claim 7, which has a deflection temperature under load of 220° C. or higher.

9. An electronic part for surface-mounting, which is produced from the molded article according to claim 7.
